(19) United States
(12) Patent Application Publication
(10) Pub. No.: US 2011/0020049 A1
(43) Pub. Date: Jan. 27, 2011

(54) Marker pen with magnetic closure arrangement

(76) Inventor: Chen Chou Liu, Taipei (TW)

Correspondence Address: SAM CHEN, 7F-1, 293, ROOSEVELT ROAD, SEC 3, TAIPEI, TW

(21) Appl. No.: 12/506,272

(22) Filed: Jul. 21, 2009

(51) Int. Cl. B43K 5/16

(52) U.S. Cl. 401/100

(57) ABSTRACT

A marker pen includes a hollow shank comprising a finger grip including a forward opening and a cavity; a spring depressible ink applicator and ink source assembly slidably disposed in the shank; a handle for actuating the assembly; a hub in the finger grip and comprising an axial channel with the ink applicator being adapted to slide therethrough, and a forward truncated conic recess being in communication with the cavity and the channel; a metal sleeve in a forward enlarged portion of the channel; and a spherical magnetic member having a diameter greater than that of the metal sleeve so as to seat on one end of the sleeve when a marking face of the ink applicator is in a non-operating position. Pushing the handle will project the marking face out of the forward opening of the shank by disengaging the magnetic member from the sleeve.

### BACKGROUND OF THE INVENTION

1. Field of Invention

The invention relates to marker pens and more particularly to a marker pen having a magnetic closure arrangement so that the nib can be sealed automatically and thus is prevented from drying after use.

2. Description of Related Art

Conventionally, a marker pen (or a highlighter) has a cap for releasably covering a nib thereof. A user may put the cap on a forward end of a shank of the marker pen so as to prevent a marking face of the marker pen from drying after use.

However, it is often that the forward portion of the shank may stick in the cap. Thus, the user has to exert a great force to detach them. Unfortunately, some people (e.g., senior citizens or children) may not the have the strength to open the cap.

There have been numerous suggestions in prior patents for marker pens. For example, U.S. Pat. No. 6,503,015 discloses a marker pen. Thus, continuing improvements in the exploitation of marker pen are constantly being sought.

### SUMMARY OF THE INVENTION

It is therefore one object of the invention to provide a marker pen having a magnetic closure arrangement so that the nib can be sealed automatically and thus is prevented from drying after use.

The above and other objects, features and advantages of the invention will become apparent from the following detailed description taken with the accompanying drawings.

### BRIEF DESCRIPTION OF THE DRAWINGS

FIG. 1 is a longitudinal sectional view of a first preferred embodiment of marker pen according to the invention where the nib is retracted within the shank;

FIG. 2 is a view similar to FIG. 1 where the nib has projected out of the shank to be ready for use;

FIG. 3 is a longitudinal sectional view of a second preferred embodiment of marker pen according to the invention where the nib has projected out of the shank to be ready for use;

FIG. 4 is a perspective view of another configuration of the marker pen shown in FIG. 3; and

FIG. 5 is a longitudinal sectional view of a third preferred embodiment of marker pen according to the invention where the nib has projected out of the shank to be ready for use.

### DETAILED DESCRIPTION OF THE INVENTION

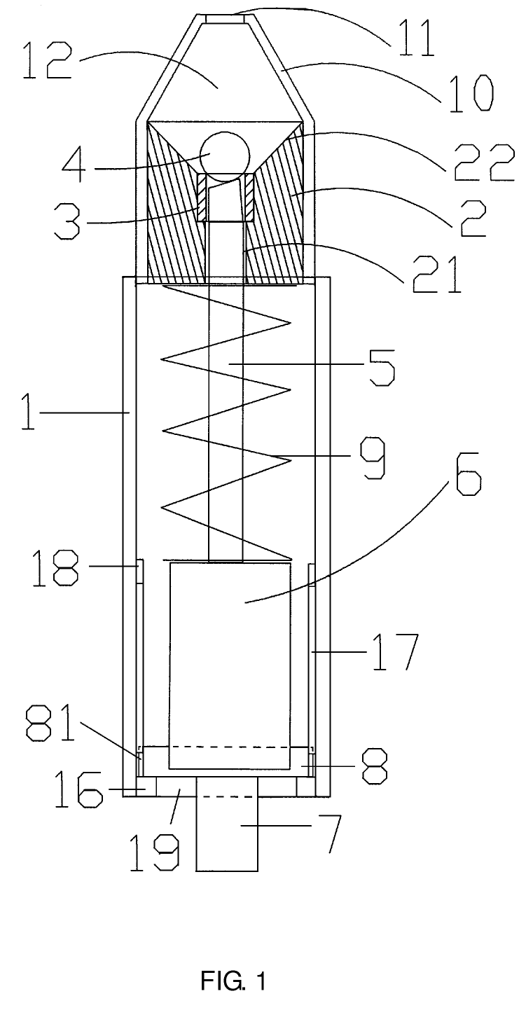

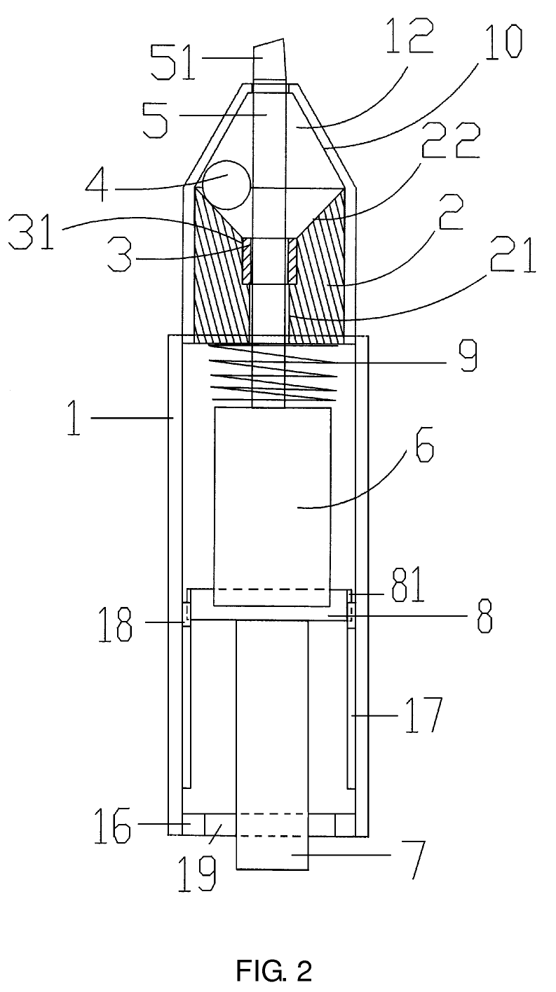

Referring to FIGS. 1 and 2, a marker pen in accordance with a first preferred embodiment of the invention comprises the following components as discussed in detail below.

A hollow shank 1 comprises a forward finger grip 10 including a forward opening 11 and an internal cavity 12 adjacent the opening 11; two opposite stop members 16 provided on an inner surface of a rear opening 19 of the shank 1; two rear opposite outer slide members 17 provided on the inner surface of the shank 1 proximate the stop members 16; and two locks 18 provided on forward ends of the outer slide members 17.

A hub 2 is provided in a rear portion of the finger grip 10 and comprises an axial channel 21 and a forward truncated conic recess 22 in communication with both the cavity 12 and the channel 21.

A metal sleeve 3 is provided in a forward enlarged portion of the channel 21. A spherical magnetic member 4 is seated on a forward opening 31 when the marker pen is in a non-operating position (see FIG. 1). The diameter of the magnetic member 4 is greater than that of the metal sleeve 3.

A disc-shaped recessed seat 8 is provided and is stopped by the stop members 16 when the marker pen is in the non-operating position. The seat 8 has two opposite inner slide members 81 on an outer surface. The inner slide members 81 are sliddably provided in the outer slide members 17. An ink cartridge 6 for containing a liquid ink is releasably provided on the seat 8 spaced from the outer slide members 17. The ink cartridge 6 is disposed between the outer slide members 17 when the marker pen is in the non-operating position.

A cylindrical ink applicator 5 has a nib 51 in the metal sleeve 3 after passing the channel 21 when the marker pen is in the non-operating position. A rear end of the ink applicator 5 is releasably secured to the ink cartridge 6 and is in communication with ink contained in the ink cartridge 6 so that the ink applicator 5 can deliver the ink from the ink cartridge 6 to the nib 51 (i.e., the marking face). A helical spring 9 is put on the ink applicator 5 and has one end urged against the hub 2 and the other end urged against the ink cartridge 6. A cylindrical handle 7 has one end fixedly secured to the seat 8 and rearward extends out of the shank 1.

An operation of the invention will be described in detail below. A user may push the handle 7 to compress the spring 9 via the seat 8 and the ink cartridge 6 with the inner slide members 81 forward sliding along the outer slide members 17 and the magnetic member 4 being pushed to disengage from the opening 31 until the seat 8 is locked by the locks 18. At this position (see FIG. 2), the spring 9 is fully compressed, the nib 51 extends out of the opening 11, and the magnetic member 4 is clamped between the ink applicator 5 and an angled joining portion of the cavity 12 and the recess 22. Thereafter, the user may use the marker pen to write.

The user may press the handle 7 again to unlock the seat 8 after use. Thereafter, the energized spring 9 automatically expands to push the ink cartridge 6 rearward with the inner slide members 81 rearward sliding along the outer slide members 17 until the seat 8 is stopped by the stop members 16. Also, the magnetic member 4 drops onto the opening 31 to seal the opening 31 due to the magnetically attracting force between the magnetic member 4 and the metal sleeve 3. At this position, the nib 51 is concealed in the metal sleeve 3 so that liquid ink in the nib 51 can be prevented from drying.

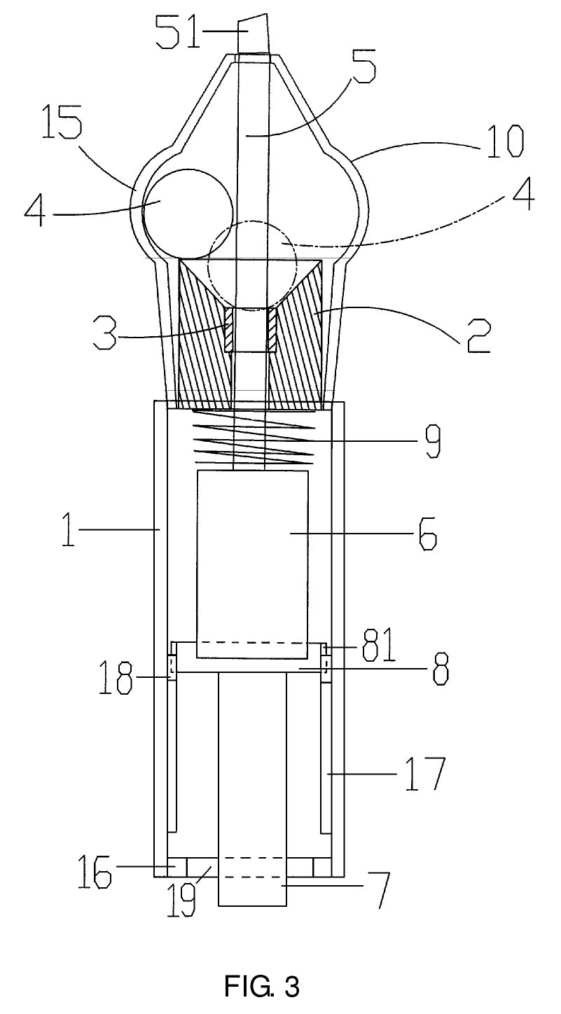

Referring to FIG. 3, a second preferred embodiment of marker pen according to the invention is shown. The second embodiment is identical to the first embodiment, except that the finger grip 10 has an annular convex member 15 on an intermediate portion thereof. The magnetic member 4 is clamped between the ink applicator 5 and the convex member 15 when the marker pen is in an operating position.

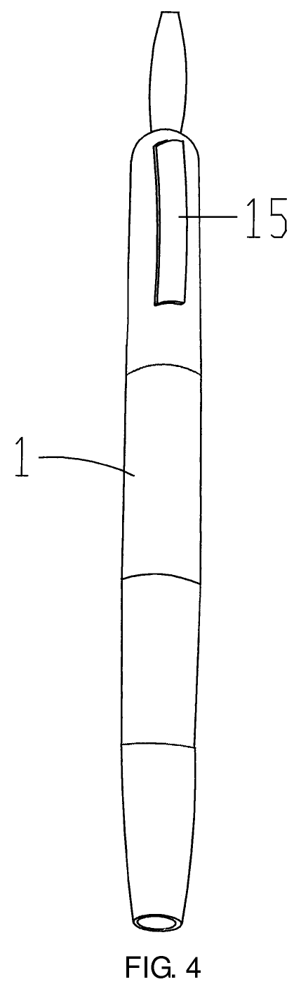

Referring to FIG. 4, another configuration of the marker pen of FIG. 3 is illustrated. The annular convex member 15 is replaced with a longitudinal, elongated convex member 15.

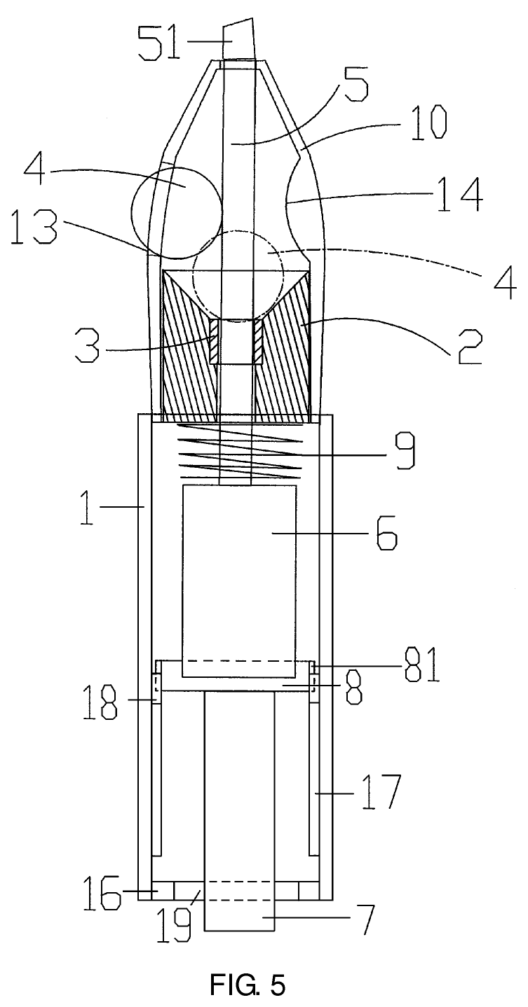

Referring to FIG. 5, a third preferred embodiment of marker pen according to the invention is shown. The third embodiment is identical to the first embodiment, except that the finger grip 10 has a hole 13 on an intermediate portion thereof, and a raised member 14 on an inner surface thereof facing the hole 13. The hole 13 has a diameter less than that of the magnetic member 4. The magnetic member 4 is clamped between the ink applicator 5 and the hole 14 and the magnetic member 4 partially extends out of the hole 13 when the marker pen is in an operating position.

While the invention herein disclosed has been described by means of specific embodiments, numerous modifications and variations could be made thereto by those skilled in the art without departing from the scope and spirit of the invention set forth in the claims.

What is claimed is:

1. A marker pen comprising:
a hollow shank comprising a forward finger grip including a forward opening and an internal cavity adjacent the forward opening;
a spring depressible assembly slidably disposed in the shank and comprising an ink source for containing a liquid ink, and an elongated ink applicator for delivering the liquid ink from the ink source to a marking face of the ink applicator;
a handle having one end supporting the ink source and the other end extending out of the shank;
a hub disposed in a rear portion of the finger grip and comprising an axial channel with the ink applicator being adapted to slide therethrough, and a forward truncated conic recess being in communication with both the cavity and the channel;
a metal sleeve disposed in a forward enlarged portion of the channel; and
a spherical magnetic member having a diameter greater than that of the metal sleeve so as to seat on one end of the sleeve when the marking face of the ink applicator is in a non-operating position,
whereby pushing the handle will project the marking face of the ink applicator out of the forward opening of the shank by disengaging the magnetic member from the sleeve.

2. The marker pen of claim 1, wherein the finger grip comprises an annular convex member on an intermediate portion.

3. The marker pen of claim 1, wherein the finger grip comprises a hole on an intermediate portion, and a raised member on an inner surface facing the hole, and wherein the hole has a diameter less than that of the magnetic member so as to clamp the magnetic member between the ink applicator and the hole with the magnetic member being partially extending out of the hole when the marking face of the ink applicator is in an operating position.
